(19) United States
(12) Patent Application Publication
(10) Pub. No.: US 2009/0308182 A1
(43) Pub. Date: Dec. 17, 2009

(54) Apparatus for collecting slurry samples from a pipe

(76) Inventor: David J. Akers, Indiana, PA (US)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/213,140

(22) Filed: Jun. 16, 2008

(51) Int. Cl. G01N 1/00

(52) U.S. Cl. 73/863.86

(57) ABSTRACT

A sampling device for obtaining a full stream cut of a slurry flowing in a pipe has a body connected in a section of pipe, with a first bore through the body forming a continuation of the pipe, and a second bore intersecting the first and supporting a cylinder for rotary and/or axial movement between first and second positions. The cylinder has a transverse bore which, in the first position is aligned with and forms a continuation of the flow path. When the cylinder is moved to the second position, the material in the transverse bore is captured and drained as a full stream cut sample. The cylinder may be quickly returned to the first position to permit continued flow through the pipe, or a second transverse bore in the cylinder may provide substantially continuous flow.

### BACKGROUND OF THE INVENTION

1. Field of the Invention

This invention relates to an improved apparatus for collecting samples of solids or slurries from a stream flowing in a pipe or other flow containment device.

2. Description of the Prior Art

Collecting samples that are representative of material flowing through flow containment devices such as pipes is known and is critical to the efficient operation of many industrial facilities such as coal cleaning and mineral processing plants. These samples are used, for example, to diagnose equipment performance, determine optimal process set-points, and for quality control of the final product.

When heterogeneous solids, such as fine-sized coal or mineral ore, flow through a pipe either as dry solids or a slurry, the particles tend to stratify within the pipe because of differences in particle size, shape and density. This stratification is accelerated by bends or curves in the flow pipe that apply centrifugal force to the flow. When the flow in a pipe is not homogeneous, collecting samples that are representative of the entire flow is very difficult, especially if the flow rate is high as is the normal case in commercial facilities such as coal cleaning plants. As samples are by definition intended to be representative of the entire population, the term “representative sample” is somewhat redundant will not be used further. Also, as used herein, the term “slurry” should be construed to mean particles suspended in a liquid such as water or in air.

It is well known that the most accurate sample of material in a flowing stream is obtained by a full stream cut of the flowing material. In the past, full stream cut samples have been collected by intermittently diverting the full flow from the pipe to a sample container, usually through a flexible hose. However, this option requires the installation of special valves and may not be feasible especially with the high flow rates normally encountered in commercial plants because of safety concerns associated with manually diverting a high flow, and automation of such samplers is expensive both to install and to operate and maintain. Also, the volume of a normal sample container may be quickly exceeded, and it is necessary to store a large quantity of material during the time between initially diverting the flow and equilibration of the flow to allow sampling. Further, diverting an entire flow may cause a process upset by starving downstream equipment of feed.

It is also known to collect samples from a low pressure or gravity flow stream in a pipe at the pipe discharge by moving a sample collecting device through the flow as it falls; however pipe discharges are normally enclosed or shrouded to prevent splashing or dusting, and the discharges are frequently located in an inaccessible area of the plant so that this option may not be available. Even where the discharge is accessible, the equipment is expensive to produce and difficult to install. This method can also present safety issues.

Another known method is to remove a short section of pipe to produce a short uncontained stream, and installing or inserting a mechanical sampler to intersect the uncontained flow. This option is not always practical because of lack of space in the plant and the sampling equipment is expensive to purchase and install. Further, spillage is difficult to contain and can result in safety issues. Also, samples of some flows such as those containing hazardous or volatile components, cannot be taken from an open stream.

Because of the difficulty and expense of collecting a sample from a pipe, industry often relies on the use of devices that are known to produce a specimen rather than a sample. For example, an opening is sometimes made in the pipe, for example, in the bottom of a sloped or inclined pipe, and a smaller pipe inserted to collect slurry. Because only the material flowing in the area of the smaller pipe inlet, for example, near the bottom of the pipe, is collected the specimen will contain not only particles whose size and density are different than those in the stream as a whole, but also will contain a different proportion of the fluid in the slurry.

In other cases, a scoop or small pipe (sometimes called a sample thief) is inserted into the flow in a pipe to divert slurry into a container. In this case, slurry collection begins as soon as the thief enters the flow and collection continues as the thief moves across the flow. Because the thief collects slurry near the insertion point for as long as it is in the flow, but only collects slurry opposite the insertion point when fully inserted, the total slurry collected contains proportionally more slurry from the side of the pipe near the insertion point.

U.S. Pat. Nos. 3,747,411 and 4,479,393 each disclose a suspension sampling device which may be mounted on a pipe and which includes a sampling probe which can be projected into and withdrawn from a pressurized suspension stream flowing in the pipe.

U.S. Pat. Nos. 5,905,213 and 6,792,818 each disclose a valve arrangement for a sampling system mounted on a pipe.

Published U.S. patent application Ser. No. 11/414,389 discloses an apparatus for and a method of collecting a product sample from a stream of the product without interrupting the flow. This is accomplished by inserting a sampling probe composed of two elongated coaxial cylinders disposed one inside the other into the stream to be sampled. The inner cylinder contains an elongated slot having a width at least slightly larger than the size of the largest particles in the flow and the outer cylinder contains a slot of similar width. Both slots are along the long axis of the cylinder and are at least as long as the transverse width of the stream of the product in the area being sampled. When a sample is to be taken, the outer cylinder is rotated relative to the inner cylinder to expose the slot in the inner cylinder to the flow stream so that the inner cylinder is simultaneously filled along its full width. The outer cylinder is rotated to cover the slot in the inner cylinder and the inner cylinder is then withdrawn to extract the sample collected through the slot extending across the full diameter of the slurry pipe. Alternatively, the sample may be permitted to flow out one end of the sampling device.

While samples taken by the device shown in this published application is representative of the flow in a section of the pipe extending thereacross along one diameter, it cannot be assured that the sample is representative of a full cut sample.

### SUMMARY OF THE INVENTION

It is a primary object of the present invention to provide an improved apparatus for collecting a sample which is a full stream cut from a stream of material flowing in a pipe, with the ease of operation and low cost of collecting a specimen with a sample thief.

Another object is to provide such an apparatus which enables taking a full cut sample from a stream flowing in a pipe without materially interrupting flow through the pipe.

In the attainment of the foregoing and other objects and advantages, an important feature of the invention resides in providing a sampling device connected in a section of the containment pipe, with the sampling device including an elongated cylinder member supported in a cylindrical bore through a sampler body and having its axis disposed transversely of and intersecting the pipe axis. The cylinder has at least one opening extending transversely therethrough, with the cross sectional size and shape of each such opening being substantially the same as that of the inside of the pipe so that, when an opening is aligned with the axis of the pipe, flow continues without interruption. The outer diameter of the cylinder is at least twice that of the diameter of the bore there-through so that, when the cylinder is rotated 90° from the flow-through position, the unbroken surface of the cylinder between the open ends of the bore will act as a valve, covering and closing the pipe.

When it is desired to take a sample cut, the cylinder is moved relative to the pipe to trap the portion of the flow in the opening in the cylinder. Since the opening through the cylinder corresponds to the inside diameter of the pipe, the trapped sample can be considered a full stream cut.

If the slurry pipe is vertical or steeply inclined, the cylinder may be moved axially (transversely of the flow pipe axis) to a position in the sampler body to align cylinder opening with a drain pipe or sample collecting container to permit the sample to flow from the cylinder opening. The cylinder can then be quickly moved back to its original position to permit flow to continue through the pipe.

When the slurry pipe is horizontal or less steeply inclined, the cylinder may simply be rotated approximately 90° degrees to briefly cut the flow through the pipe and trap a full stream cut in the cylinder opening, and to align the cylinder opening with a drain opening in the sampler body to permit the sample to drain from the cylinder opening, then quickly rotated back to its original position to permit flow to continue through the pipe.

Movement of the cylinder to trap and drain the sample, and to return the cylinder to the flow-through position can be accomplished in a very short time—only a few seconds—so that for many slurries transported in pipes, especially relatively small pipes, the brief interruption in flow will not adversely affect the flow.

When a flow interruption of a few seconds cannot be tolerated a second sampler collecting opening may be provided in the cylinder, with the second opening being axially spaced from but in close proximity to the first opening. In this embodiment, when a sample is to be taken, the cylinder is always moved axially to bring the second opening into alignment with the flow stream in the pipe as the first opening containing the sample cut is moved from the flow stream. The two sample collection openings may be parallel or at right angles to one another, depending on whether or not it is necessary or desirable to rotate the cylinder to facilitate emptying the sample from the first opening. The process may be simply reversed when a second sample is to be taken.

Any suitable means may be provided for moving the cylinder in the block. For example, a lever or hand wheel may be employed to rotate the cylinder and a spiral cam and follower employed to provide simultaneous axial movement. Alternatively, a reversible electric or fluid motor may be employed to move the cylinder.

### BRIEF DESCRIPTION OF THE DRAWINGS

Other features and advantages of the invention will become apparent from the detailed description contained herein below, taken in conjunction with the drawings, in which:

FIG. 1 is a bottom plan view of a first embodiment of the sampling device embodying in the invention installed in a general horizontal slurry pipe;

FIG. 2 is a sectional view of the device taken along line 2-2 of FIG. 1;

FIG. 3 is a sectional view of the device taken along line 3-3 of FIG. 2;

FIG. 4 is a view similar to FIG. 1 of an alternate embodiment of a sampler embodying the invention;

FIG. 5 is sectional view taken along lines 44 of FIG. 3;

FIG. 6 is a fragmentary isometric view of a portion of the device shown in FIGS. 4 and 5 and illustrating one means for actuating the sampling device; and

FIG. 7 is an elevation view in section showing a third embodiment installed in a generally vertical slurry pipe.

### DESCRIPTION OF THE PREFERRED EMBODIMENTS

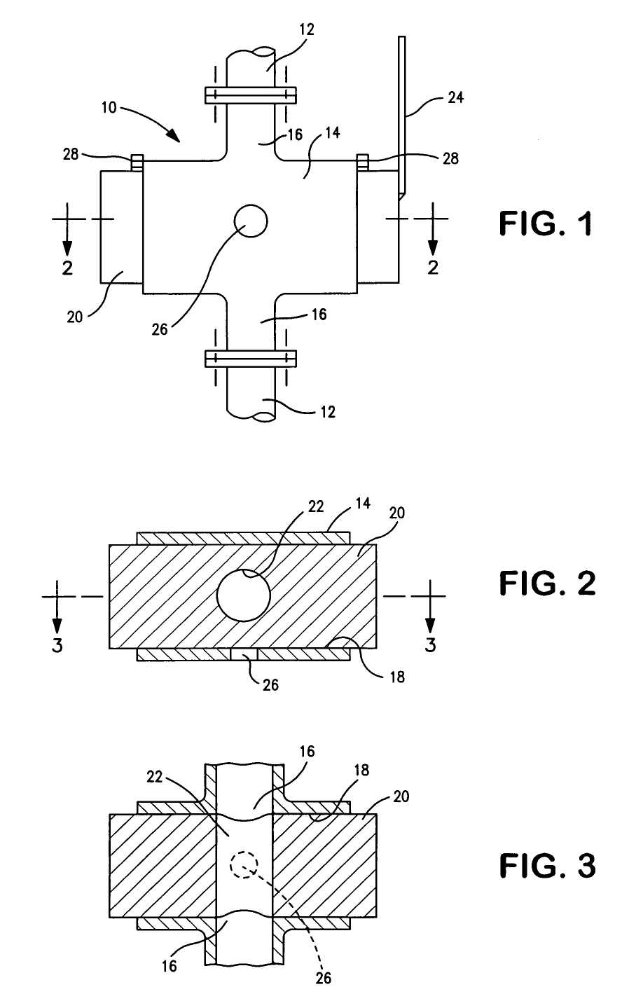

Referring now to the drawings, a first embodiment of a sampling device according to the invention is designated generally by the reference number 10 and illustrated in FIGS. 1 and 2 is installed in a generally horizontal or slightly inclined slurry conveying pipe 12. Sampler 10 comprises a valve body 14 in the form of a 4-way pipe cross fitting having a first through bore 16 in one direction corresponding in diameter to and connected in line with the slurry pipe 12, and a second through bore 18 at least two times, and preferably slightly greater than two times that of the first bore. The first and second bores are perpendicular to one another.

A valve-like sample collecting cylinder 20 having an outside diameter corresponding to that of and is rotatably mounted in the second bore 18. The diameter of bore 18 and of cylinder 20 are at least twice that of the inside diameter of pipe 12 and of the first bore 16. A transverse sampler collecting bore 22 or chamber is formed in cylinder 20, with the axes of bore 16 and bore 22, and cylinder 20 intersecting at a common point. Suitable retaining means such as snap rings or set screws disposed in end portions of cylinder 20 adjacent the open ends of bore 18 retain the cylinder in axial position in body 14, and a manually actuated lever 24 rigidly joined to one end of cylinder 20 is provided to rotate the cylinder between a flow-through position in which the axis of bore 22 is aligned with the axis of pipe 12, and a sample-taking position 90° from the flow-through position and in which the axes of the pipe and bore 22 are perpendicular to one another. Suitable stops, not shown, may be provided to limit rotation of cylinder 20.

A sample outlet bore 26 is formed in body 14, with its axis located 90° from and intersecting the axis of bore 22. In the flow through position, outlet 26 is closed by the surface of cylinder 20, while in the sample-taking position, outlet 26 is in direct communication with the sampler collecting bore 22, permitting the sample to flow from the device into a suitable container or conduit.

In operation of this embodiment the cylinder 20 is normally in the flow-through position which provides no interference with flow through pipe 12. When it is desired to take a sample from the slurry stream, lever 24 is moved rapidly to rotate cylinder 20 through 90°, thereby temporarily interrupting flow through the pipe 12 and trapping the portion of the slurry stream flowing through the sample collecting bore 22. This rotation of cylinder 20 brings the sample collecting bore 22 into communication with outlet 26, permitting the trapped sample to drain from the device, after which the lever 24 is actuated to rotate cylinder 20 back to the flow-through position. Axial movement of cylinder 20 is prevented by suitable stops such as set screws 28, or snap rings (not shown) on the protruding end portions of cylinder 20 adjacent the open ends of bore 18.

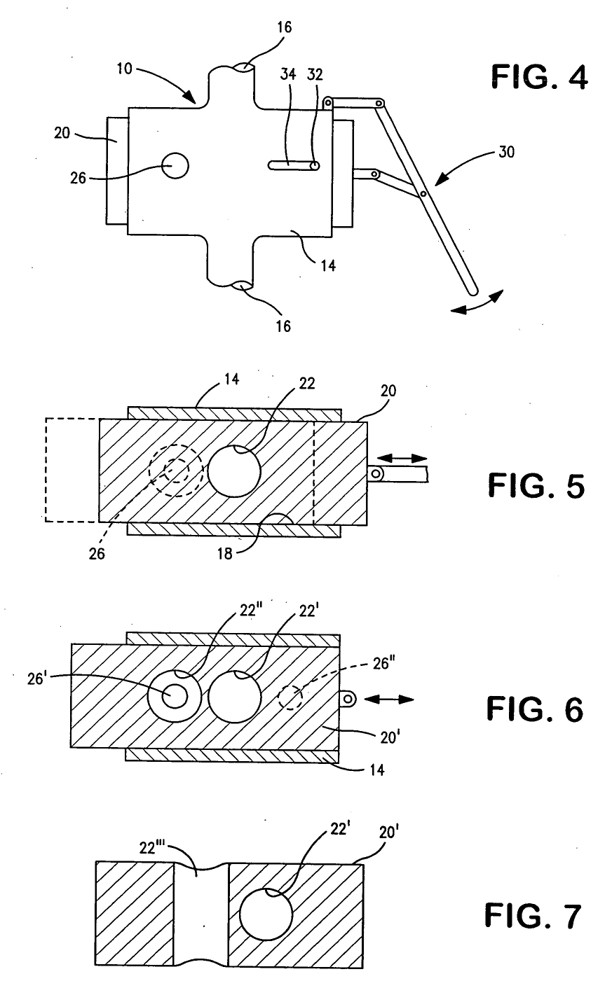

In a modification of the sampling device described above, the cylinder 20 is supported for axial sliding movement in the bore 14 between the flow-through position and a sampling position. This modification is particularly well suited for use in a vertical or more steeply inclined pipe section, and the drain outlet 26 in body 14 is spaced axially from the bore 22 in a position spaced laterally of the pipe 12. Also, the rigid lever 24 may be replaced with a toggle lever assembly 30 mounted on the body 14 and engaging one end portion of the cylinder 20 for axial movement thereof as illustrated schematically in FIG. 4.

Rotation of the cylinder 20 about its longitudinal axis during movement may be prevented by the toggle lever 30, or by other suitable means such as a stationary pin 32 projecting radially from the cylinder and projecting into an axially extending guide groove or slot 34 in the outer surface of the cylinder. Alternatively, the guide groove 34 may extend in a spiral path so that actuation of the toggle lever imparts both axial and rotational movement to the cylinder to position the cylinder for more efficient emptying of the sample chamber. It is also understood that the outlet 26 may be eliminated in this modification, in which case, the toggle lever 30 moves the cylinder laterally until the sample collecting bore 22 projects past the end of the second bore 18 to permit the samples to flow into a suitable container or conduit. The pin 32 engaging the ends of the guide slot 34 may be employed to limit axial movement of cylinder 20 between the flow through and sampling positions. Also when spiral movement is imparted to the cylinder 20, the outlet bore 26 may be moved to a position aligned with the sample collecting bore 22 to permit discharge of the sample.

In an alternate embodiment shown in FIG. 7, the cylinder 20′ has two transversely extending sample collecting bores 22′ and 22″ in axially spaced relation closely adjacent to one another, and the cylinder is moved axially in bore 18 to alternately place the sample chambers in axial alignment with the pipe bore so that flow through the pipe is never completely interrupted. By rapidly moving the cylinder transversely of the flow stream, one sample collecting bore 22′ captures an essentially full cut sample which is moved laterally of the flow stream and collected in the manner described above while the second flow collecting bore 22″ is simultaneously moved into alignment with the flow pipe. When a second sample is to be collected, the procedure is simply reversed, with the captured samples being discharged from the respective sample collecting bores on opposed sides of the sampler body.

In this dual collecting bore embodiment, the bores 22′ and 22″ may be formed with their axes in planes perpendicular to one another, in which case, the cylinder 20′ is simultaneously rotated and moved axially in the manner described above.

The successful transportation of slurries through a pipe depends on maintaining a sufficient flow velocity to keep the particles in suspension. The required velocity will depend on many factors, the principle ones being the size and specific gravity of the product particles, the size and contour of the conveying pipe, and the concentration of the solid particles in the conveying liquid.

It has been found that in many commercial installations such as coal washing and cleaning operations, flow of a slurry in a pipe can be interrupted for a brief period of up to several seconds, then restarted without the suspended particles separating or settling out and blocking or restricting flow. In such cases, the embodiment of the present invention employing a single sample collecting bore in the cylinder may be used to obtain a substantially full stream cut sample of the flowing stream in an easy and efficient manner. When minimum flow interruption is necessary, it is still possible to obtain the full stream cut sample by employing the dual collecting bores. Also, the sampling device is not restricted to use in either horizontal or vertical pipes, and may be installed in any convenient location.

While preferred embodiments of the invention have been disclosed and described, it is believed apparent that many modifications may be made. For example, operation of the sampling device could readily be automated, using reversible electric or fluid motors to impart movement to the cylinder. Therefore it is not intended that the invention be limited to the disclosed embodiments, but rather it is intended to include all embodiments which would be apparent to one skilled in the art and which come within the spirit and scope of the invention.

I claim:

1. A sampling device for obtaining a full stream cut of a material flowing in a pipe, the device comprising
a sampler body,
a first bore extending through the sampler body, the first bore having a diameter corresponding to the inside diameter of the pipe,
a second bore extending through the sampler body, the second bore having its axis extending perpendicular to and intersecting the axis of the first bore and having a greater than the diameter of the first bore,
a cylinder having a diameter corresponding to the diameter of and moveably mounted in the second bore,
a sample capturing bore formed in and extending transversely through said cylinder, said sample capturing bore having its axis perpendicular to and intersecting the axis of the cylinder and having a diameter corresponding to the diameter of said first bore,
actuator means for moving said cylinder within said second bore between a flow-through position in which said sample capturing bore is axially aligned with the pipe to form a continuous flow path through the device and a second position in which the sample capturing bore is isolated from the flow path to capture material from the stream in the sample capturing bore, and
sample outlet means permitting the captured material to flow from the sample capturing bore at the second position.

2. The sampling device defined in claim 1, wherein said actuator means comprises means for rotating said cylinder about its longitudinal axis within said second bore.

3. The sampling device defined in claim 2, wherein the outlet means comprises a third bore formed in said body and communicating with said second bore, the axis of said third bore intersecting and being substantially perpendicular to the axes of said first and second bores.

4. The sampling device defined in claim 1, wherein actuator means comprises means for moving said cylinder axially within said second bore.

5. The sampling device defined in claim 4, wherein said outlet means comprises a third bore formed in said body and communicating with said second bore at a location spaced from said first bore.

6. The sampling device defined in claim 1, wherein said actuator means comprises means for simultaneously rotating and axially moving said cylinder in said second bore.

7. The sampling device defined in claim 6, wherein said actuator means comprises cam means on said cylinder and said on body cooperating to import rotation to said cylinder upon axial movement thereof.

8. The sampling device defined in claim 6, wherein said outlet means comprises a third bore formed in said body and communicating with said second bore at a location spaced from said first bore.

9. The sampling device defined in claim 1, further comprising a second sample capturing bore formed in and extending through said cylinder in closely spaced axial relation to said first sample capturing bore, and wherein said actuating means comprises means for axially moving said cylinder between first and second positions to alternately place one of said sample capturing bores in the flow-through position and the other sample capturing bore in a position isolated from the flow path and capturing material from the stream.

10. The sampling device defined in claim 9, wherein said first and second sample capturing bores are parallel.

11. The sampling device defined in claim 9, wherein said sample outlet means comprises means permitting captured material to flow from the respective sample capturing bores at diametrically opposed sides of the flow stream through the sampling device.

12. The sampling device defined in claim 9, wherein said first and second sampling bores have their axes offset by about 90° with respect to one another about the axis of said cylinder.

13. The sampling device defined in claim 12, wherein said actuator means comprises means simultaneously imparting both rotary and axial movement to said cylinder upon movement between said first and second positions.
